(19) United States
(12) Patent Application Publication
(10) Pub. No.: US 2017/0071375 A1
(43) Pub. Date: Mar. 16, 2017

(54) AIRLINE TRAY SLEEVE

(71) Applicant: Marvin Smith, Orlando, FL (US)

(72) Inventor: Marvin Smith, Orlando, FL (US)

(21) Appl. No.: 14/853,454

(22) Filed: Sep. 14, 2015

(51) Int. Cl. A47G 11/00; B65D 33/28; B65D 85/62; B65D 83/08; B64D 11/06; B65D 33/00

(52) U.S. Cl. CPC A47G 11/004; B64D 11/0638; B65D 33/004; B65D 85/62; B65D 83/0805; B65D 33/28

(57) ABSTRACT

An airline tray sleeve includes a main body having a top surface, a bottom surface and a side surface that define an interior space. An opening having a retention device is positioned along a back end of the main body. One or more pockets are suspended from the main body, and the sleeve is constructed from a lightweight malleable material that transforms into a refuse bag after use.

### TECHNICAL FIELD

The present invention relates generally to sanitation devices, and more particularly to a disposable airline tray sleeve capable of covering any type of airline tray to provide a clean surface.

### BACKGROUND

The statements in this section merely provide background information related to the present disclosure and may not constitute prior art.

By far, the most commonly utilized feature on commercial airlines is the seatback tray. Depending on the particular aircraft manufacturer and/or class of seating, the tray can be located within the armrest or, more commonly, on the back side of each passenger seat. In either instance, the airline tray functions as a platform onto which passengers can place personal items such as computers or books, for example, and as a table onto which food items such as meals and drinks can be placed.

Owing to the hardened plastic construction of airline trays, combined with the movement of the cabin during flight, it is not uncommon for beverages placed onto the trays to spill. When this occurs, the liquids often run off of the nonabsorbent tray surface and onto the users lap. Depending on the type of beverage, this may result in a stain to the users clothing. Moreover, crumbs and other food debris from each passenger's snacks are often left on the tray when it is folded into position for landing. As such, these items stain the seatback, and/or fall into the seat pocket where they can remain unnoticed for long periods of time.

In recent years, airlines have moved the responsibility to clean the airline cabins onto flight attendants. In this regard, such crews (typically between 3 and 5 people) are given around 20 minutes to clean upwards of 300 seats, including the lavatories, carpets and checking each overhead bin for items that may have been left behind. With this in mind, there is virtually no way to individually clean and/or sanitize each seatback tray. As such, it is no wonder that several studies confirm that airline trays are among the dirtiest objects that passengers encounter during their entire trip.

Accordingly, it would be beneficial to provide a cover which can surround an entire airline tray, to provide a clean space for passengers, thereby overcoming the issues described above.

### SUMMARY OF THE INVENTION

The present invention is directed to an airline tray sleeve. One embodiment of the present invention can include a main body having a top surface, a bottom surface and a side surface that define an interior space. The main body can include a shape and size that conforms to the shape and size of an airline tray, and the same can be removably positioned within the interior space of the sleeve via an opening. The airline tray sleeve can also include a retention device for securing the main body onto the airline tray, when the same is in either the extended or folded position.

Another embodiment of the present invention can include a pocket that is suspended from the main body for providing additional storage of personal belongings during use. Additionally, the main body can be constructed from a lightweight malleable material that can be folded into a bag and discarded after usage. The main body can also be biodegradable in nature, and can further include an antibacterial coating to prevent the spread of contaminants within the aircraft cabin.

Yet another embodiment of the present invention can include an airline tray sleeve kit having a plurality of individual sleeves that are folded within a container and are selectively removed prior to use.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a plan view of an airline tray sleeve that is useful for understanding the inventive concepts disclosed herein.

FIG. 2A is a perspective view of the airline tray sleeve in operation, in accordance with one embodiment of the invention.

FIG. 2B is a perspective view of the airline tray sleeve secured onto an airline tray in the extended position, in accordance with one embodiment of the invention.

FIG. 2C is a perspective view of the airline tray sleeve secured onto an airline tray in the stowed position, in accordance with one embodiment of the invention.

FIG. 2D is a perspective view of the airline tray sleeve in an inverted refuse bag position, in accordance with one embodiment of the invention.

FIG. 3 is a perspective view of an airline tray sleeve kit, in accordance with one embodiment of the invention.

FIG. 4 is a perspective view of the airline tray sleeve, in accordance with another embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

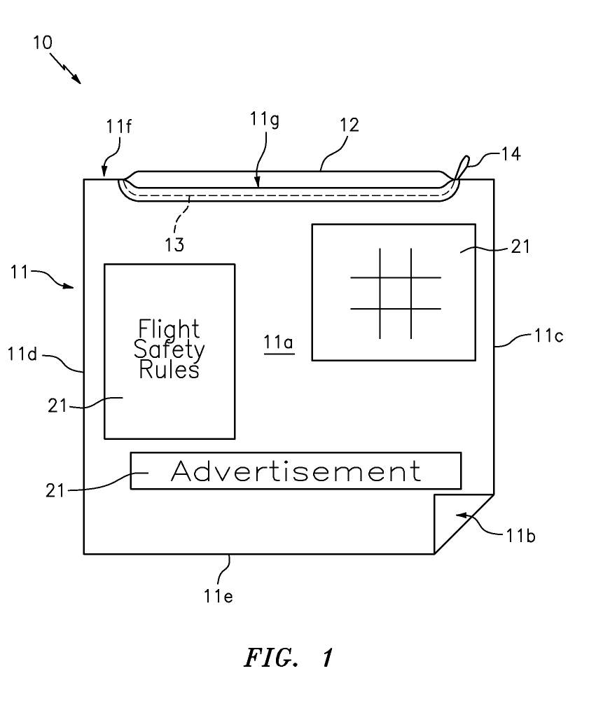

Identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

FIGS. 1-4 illustrate various embodiments of an airline tray sleeve device 10 that is useful for understanding the inventive concepts disclosed herein. As shown, the device 10 can include a lightweight sleeve 11 having a retention device 13 positioned along the back portion thereof.

The sleeve 11 can act as a shield that encompasses an airline tray. To this end, the sleeve will act as a lightweight physical barrier capable of preventing small spills, crumbs and other such materials from making contact with the tray. In one embodiment, sleeve 11 can include a generally rectangular-shaped bag design having a top surface 11a, a bottom surface 11b, and a connecting surface such as a pair of opposing side portions 11c and 11d, a front end 11e, and back end 11f. Each of these sections defining a generally hollow interior space 11g into which an airline tray can be positioned. As shown, an opening 12 can be disposed along the back end so as to provide access to the interior space.

The sleeve 11 can be manufactured in various dimensions so as to fit onto airline trays. Accordingly, the sleeve can be constructed to fit seatback trays, armrest trays, and/or can be constructed as a one size fits all. In either instance, various embodiments of the sleeve 11 can be sprayed with an antibacterial coating during a time of manufacture, so as to actively repel harmful substances within the aircraft cabin.

In one embodiment, the sleeve 11 can be disposable and/or biodegradable in nature and can be constructed from lightweight absorbent paper, for example, or other such materials. In one preferred embodiment, the sleeve can be constructed from a combination of fused cotton and paper towels, so as to produce a soft material that provides the appearance of linen, but the cost effectiveness and convenience of disposable paper.

Although described above with respect to a specific size, shape and/or material, one of skill in the art will recognize that the sleeve 11 can include any number of different shapes (i.e. contours), sizes, materials and/or construction methodologies. Moreover, in another embodiment, the device 10 can be reusable in nature, and the sleeve 11 can be constructed from any number of materials such as cotton, or polyester, for example. Such an embodiment of the device would be made commercially available for individual purchase by consumers who can launder the same between trips.

In one embodiment, a retention device 13 can be disposed about the periphery of the opening 12, so as to secure the device onto the tray when being used. In one preferred embodiment, retention device 13 can include a thin elastic band (e.g., strands of weaved latex and/or rubber) that can maintain the opening 12 in a closed or semi-closed position. Alternatively, or in addition to the elastic band, one or more drawstring(s) 14 can also be provided, so as to allow a user to manually pull the opening into a closed position.

The airline tray sleeve device can include any type of indicia 21, suitable for display within an aircraft cabin. As described herein, indicia can include an unlimited number of decorative elements, colors, markings, words, shapes, symbols, logos, designs, patterns, images, and/or photographs, for example. These indicia can encompass various free or paid advertisements, aircraft safety information, destination information, in-flight menu or optional services, and/or child entertainment activities (e.g., images for coloring with crayons). The indicia can be secured onto and/or into the main body in accordance with known techniques so as to be flush with the surface of the main body or can be raised/protruding outward from the main body so as to give a three dimensional effect. In the preferred embodiment, indicia located on the top surface 11a will be inverted with respect to any indicia located on the bottom surface 11b. Such a feature ensuring that the words or images will be properly oriented when the tray are in both the open and closed position.

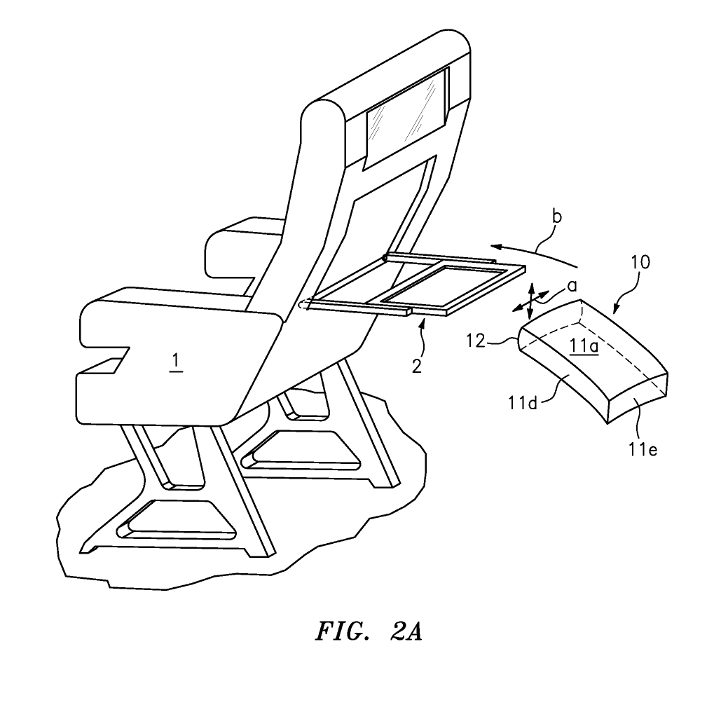

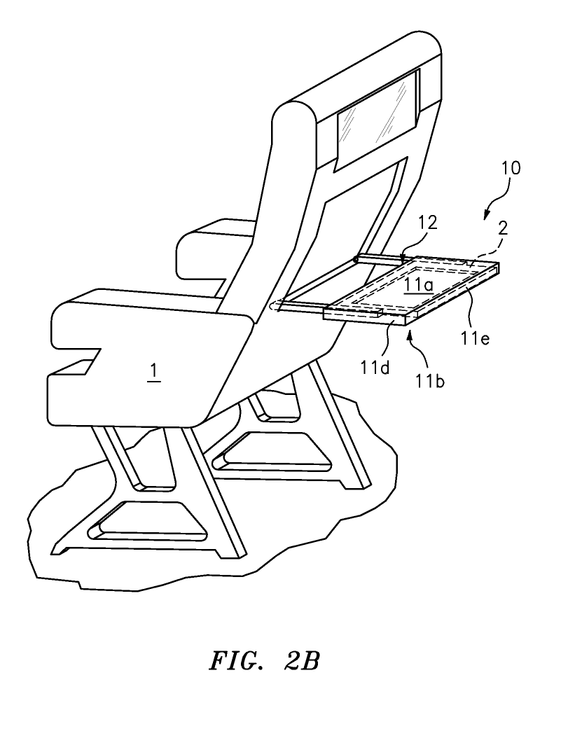

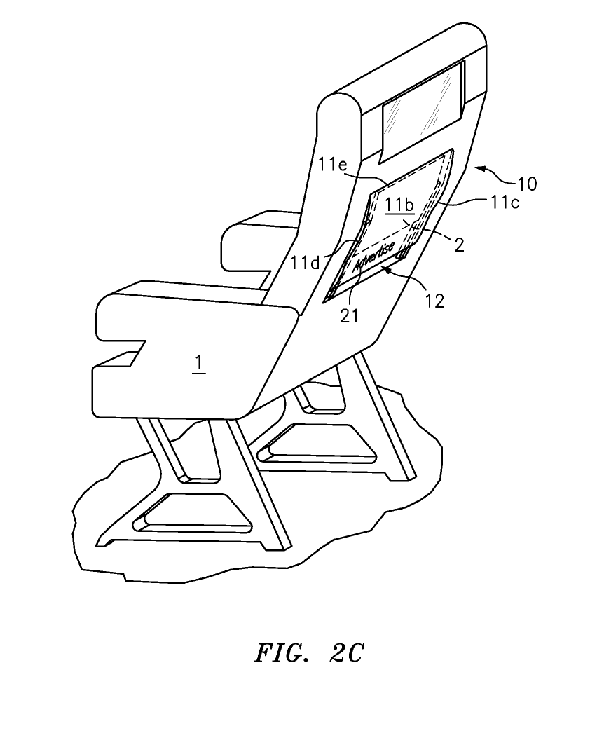

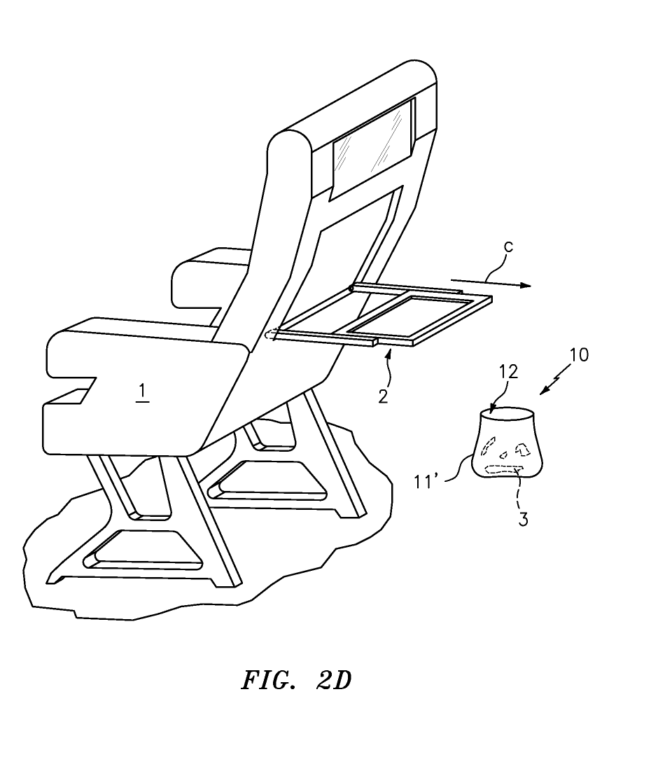

FIGS. 2A-2D illustrate one embodiment of the device 10 in operation. As shown, the airline tray sleeve device can function to cover any type of airline tray 2, so as to provide a clean surface for each passenger. In one embodiment, the device can be installed by stretching the opening 12 (see arrow a) into an expanded state, and then sliding the tray 2 within the interior section of the sleeve 11, as shown by arrow b. Once positioned, the resilient nature of the elastic band can function to automatically close about the rear end of the tray and/or the user can pull the drawstring to close the opening.

In either instance, and as shown at FIG. 2C, by placing the tray 2 within the protective sleeve, passengers are protected from contact with both the top and bottom surfaces of the tray, even when the tray is in the upright position. As such, in various instances, the tray of each airline seat 1 can be fitted with a device 10 by the cabin crew before passengers board the plane, thereby ensuring a clean surface at all times.

Moreover, as shown, in FIG. 2D, at the conclusion of the flight, each passenger or flight crew can remove the device 10 (see arrow c) by turning the sleeve inside out. In this regard, the inside-out sleeve 11′ functions as a garbage/refuse bag for disposing of personal passenger items 3 that were used during the flight. Such a feature can assist the cabin crew in preparing the passenger compartment for landing, while preventing such trash from accumulating in the seatback pocket.

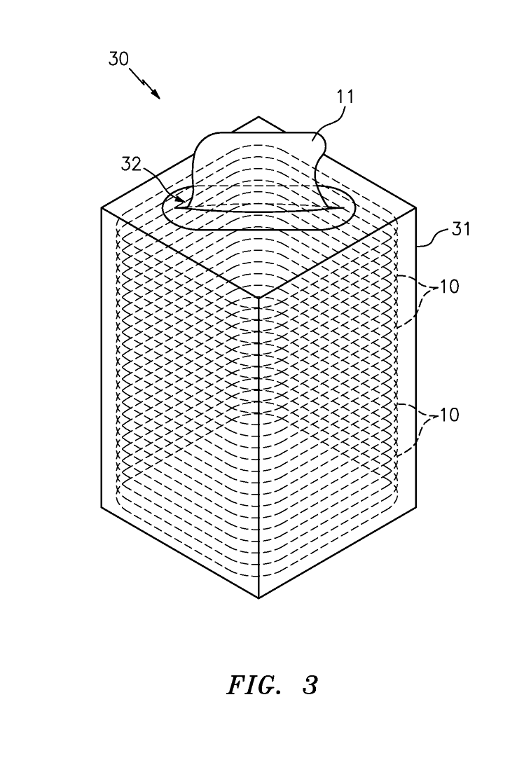

As described above, one embodiment of the device 10 can be disposable in nature. As such, it is preferred that each device be manufactured so as to be packaged, shipped and stored in a folded orientation until ready for use by airline crews during a flight. To this end, FIG. 3 illustrates one embodiment of an airline tray sleeve kit 30 that includes a plurality of individual tray sleeves 10 that are folded and stored within a container 31 having an opening 32 for dispensing the same.

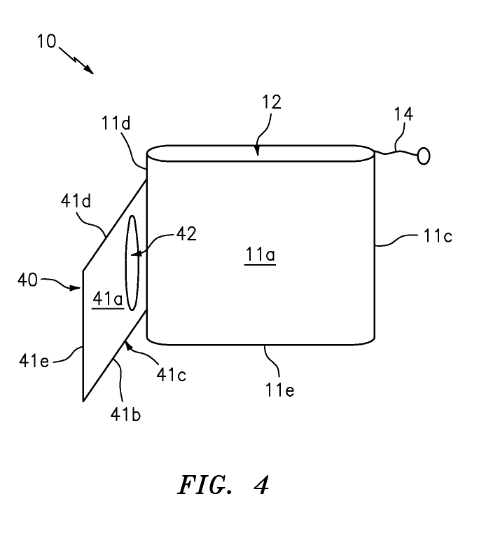

FIG. 4 illustrates another embodiment of an airline tray sleeve device 10 that further includes one or more hanging pockets 40 which can be suspended from the sleeve body. As shown, the pocket 40 can include a plurality of sides 41a-41e that define an interior space 42 into which any number of user items can be placed. Of course, any number of other pockets can also be provided that are integrated into the main body, so as to not be suspended therefrom.

As described herein, one or more elements of the airline tray sleeve device 10 can be secured together utilizing any number of known attachment means such as, various glues, resin and/or stitches for example. Moreover, although the above embodiments have been described as including separate individual elements, the inventive concepts disclosed herein are not so limiting. To this end, one of skill in the art will recognize that one or more individual elements may be formed together as one continuous element through known manufacturing processes, with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An airline tray sleeve device, comprising:
a main body having a top surface, a bottom surface, and a connecting surface that define a hollow interior space, said opening including a shape and dimension that is suitable for covering an entirety of an airline tray;
an opening that is disposed along the connecting surface of the main body, said opening including a dimension that is suitable for receiving the airline tray, and is configured to provide access to the interior space; and
a retention device that is configured to secure the opening in a closed orientation.

2. The device of claim 1, wherein the main body includes a malleable, generally rectangular shape that is constructed from a lightweight absorbent material.

3. The device of claim 2, wherein the main body further includes an antibacterial coating.

4. The device of claim 1, wherein the retention device comprises an elastic band that is disposed about a periphery of the opening.

5. The device of claim 1, wherein the retention device comprises a drawstring that is disposed about a periphery of the opening.

6. The device of claim 1, wherein the retention device comprises both an elastic band and a drawstring that are each disposed about a periphery of the opening.

7. The device of claim 1, wherein the main body is constructed from lightweight malleable paper, that is configured to be positioned inside-out so as to function as a garbage bag for storing discarded items.

8. The device of claim 1, wherein the main body is constructed from a blend of lightweight malleable paper and cotton that is configured to be positioned inside-out so as to function as a garbage bag for storing discarded items.

9. The device of claim 1, wherein the main body is constructed from a lightweight malleable disposable material that is configured to be packaged, shipped and stored in a folded orientation.

10. The device of claim 1, further comprising:
at least one hanging pocket that is suspended from the main body.

11. The device of claim 1, further comprising:
a first indicia that is disposed along the top surface of the main body; and
a second indicia that is disposed along the bottom surface of the main body,
wherein the first and second indicia are provided in an inverted relation to each other.

12. An airline tray sleeve kit, comprising:
a plurality of folded tray sleeves, each including
a main body having a top surface, a bottom surface, and a connecting surface that define a hollow interior space, said opening including a shape and dimension that is suitable for covering an entirety of an airline tray,
an opening that is disposed along the connecting surface of the main body, said opening including a dimension that is suitable for receiving the airline tray, and is configured to provide access to the interior space, and
a retention device that is configured to secure the opening in a closed orientation; and
a container that is configured to store each of the plurality of folded tray sleeves, said container including an opening that is configured to allow each of the stored tray sleeves to be selectively removed therefrom.
